(19) United States
(12) Patent Application Publication
(10) Pub. No.: US 2012/0281194 A1
(43) Pub. Date: Nov. 8, 2012

(54) POSITIONING APPARATUS, EXPOSURE APPARATUS, AND METHOD OF MANUFACTURING DEVICE

(75) Inventor: Tosiya Asano, Utsunomiya-shi (JP)

(73) Assignee: CANON KABUSHIKI KAISHA, Tokyo (JP)

(21) Appl. No.: 13/461,997

(22) Filed: May 2, 2012

(30) Foreign Application Priority Data
May 6, 2011 (JP) 2011-103787

(51) Int. Cl. G03B 27/54; B23Q 3/15

(52) U.S. Cl. 355/67; 335/289; 355/77

(57) ABSTRACT

A positioning apparatus controls a relative position between a first member and a second member. The apparatus includes an electromagnet fixed to the first member, an attraction target fixed to the second member so as to be attracted by the electromagnet, a magnetic flux sensor which detects a magnetic flux value generated by the electromagnet, and a driving unit which drives the electromagnet in accordance with an error between the magnetic flux value detected by the magnetic flux sensor and a corrected magnetic flux command value obtained by correcting a magnetic flux command value in accordance with a size of a gap between the electromagnet and the attraction target.

### BACKGROUND OF THE INVENTION

1. Field of the Invention

The present invention relates to a positioning apparatus, an exposure apparatus, and a method of manufacturing a device.

2. Description of the Related Art

In an exposure apparatus which manufactures a device such as a semiconductor device, a substrate stage mechanism and an original stage mechanism are required to achieve moving stages at a high acceleration and a high speed, and positioning these stages with high accuracy. It is common practice to employ a coarse/fine moving stage mechanism in which a fine moving stage which has a small stroke but high positioning accuracy is disposed on a coarse moving stage which has low positioning accuracy but a large stroke and high thrust characteristics. As an actuator which drives the fine moving stage, a linear motor which uses a Lorentz force or an electromagnet which uses an attractive force can be employed. The former can be easily used because its characteristics describing the sequence from when a force command is issued until a thrust is produced has high linearity, while the latter is advantageous in reducing heat generated by the actuator. Hence, a method of performing positioning control using a linear motor, and performing acceleration/deceleration using an electromagnet is available. To ensure high positioning accuracy, it is necessary to improve the accuracy of a force generated by the electromagnet for acceleration/deceleration to reduce a position error during acceleration/deceleration, and, in turn, to accurately control the generated force. Japanese Patent Laid-Open No. 3-43766 and Japanese Patent No. 3977086 describe control methods which solve a problem resulting from nonlinearity of the force generated by the electromagnet.

In the control method described in Japanese Patent Laid-Open No. 3-43766, the force generated by the electromagnet is regarded to be approximately proportional to the square of the coil current, the square root of the absolute value of a force command value is calculated, and this square root is multiplied by a gain, thereby generating a coil current command value. Note that since the magnetic flux value changes with a change in size of the gap between the electromagnet and an attraction target, the current command is corrected based on the measurement value of this gap. However, in such a control method, even if the coil current value remains the same, the force varies in the course of increasing/decreasing the current value, due to the influence of the magnetic hysteresis of an electromagnet core. In the control method described in Japanese Patent No. 3977086, a magnetic flux value is detected in place of a current value, and the force is controlled based on the magnetic flux value. The control method described in Japanese Patent No. 3977086 is based on the idea that the detected magnetic flux value includes the influence of the magnetic hysteresis and the gap, so the force can be controlled free from any such influence by controlling this magnetic flux value.

When the force of the electromagnet is controlled by controlling the magnetic flux value, the relationship between the magnetic flux value detected with a change in size of the gap and the force generated by the electromagnet problematically changes. That is, even if the magnetic flux value is controlled in accordance with the command value, a target force cannot be obtained upon a fluctuation in force generated by the electromagnet due to a change in size of the gap.

### SUMMARY OF THE INVENTION

The present invention provides a technique advantageous in preventing degradation in positioning accuracy due to a fluctuation in size of the gap between an electromagnet and an attraction target.

One of the aspects of the present invention provides a positioning apparatus which controls a relative position between a first member and a second member, comprising: an electromagnet fixed to the first member; an attraction target fixed to the second member so as to be attracted by the electromagnet; a magnetic flux sensor which detects a magnetic flux value generated by the electromagnet; and a driving unit which drives the electromagnet in accordance with an error between the magnetic flux value detected by the magnetic flux sensor and a corrected magnetic flux command value obtained by correcting a magnetic flux command value in accordance with a size of a gap between the electromagnet and the attraction target.

Further features of the present invention will become apparent from the following description of exemplary embodiments with reference to the attached drawings.

### BRIEF DESCRIPTION OF THE DRAWINGS

FIG. 1 is a block diagram for explaining a feedforward control system in a positioning apparatus according to an embodiment of the present invention;

FIG. 2 is a block diagram for explaining a feedback control system in the positioning apparatus according to the embodiment of the present invention;

FIG. 3 is a schematic view of a measuring device which measures the characteristics of an electromagnetic actuator;

FIG. 4 is a graph illustrating the relationship between the gap and the correction value;

FIG. 5 is a block diagram for explaining a feedforward control system in a positioning apparatus according to another embodiment of the present invention; and

FIG. 6 is a view showing the schematic configuration of an exposure apparatus according to an embodiment of the present invention.

### DESCRIPTION OF THE EMBODIMENTS

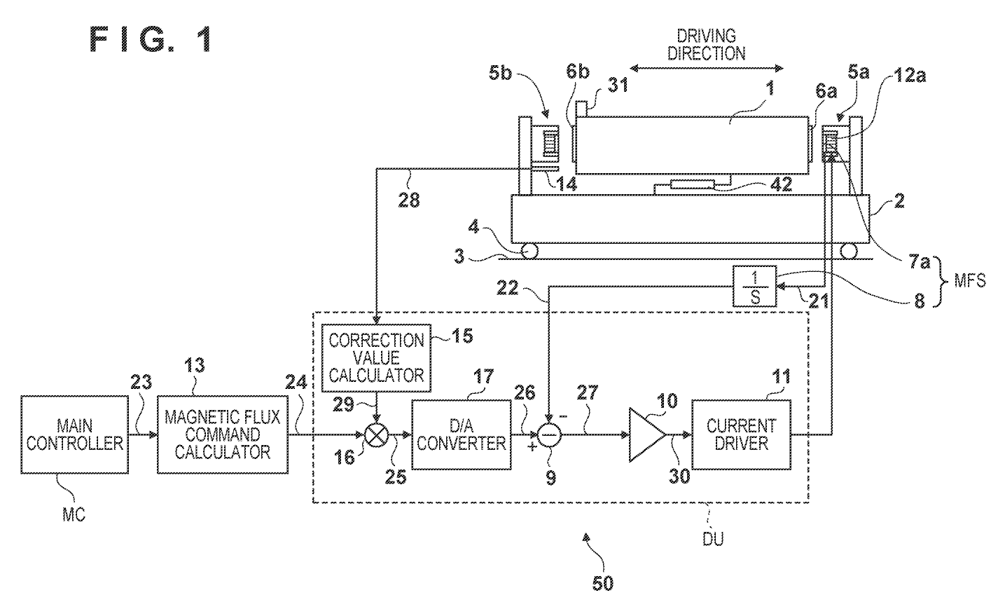

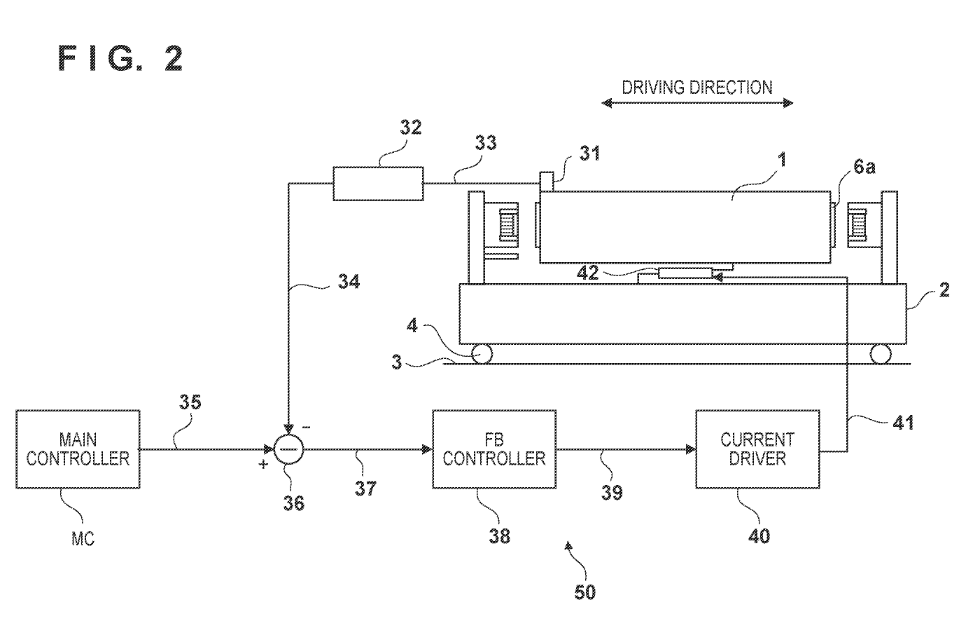

The configuration and operation of a positioning apparatus 50 according to an embodiment of the present invention will be described with reference to FIGS. 1 and 2. The positioning apparatus 50 includes a feedforward control system which performs feedforward control of a force applied to a fine moving stage 1 serving as an object to be positioned, and a feedback control system which performs feedback control of the position of the fine moving stage 1. FIG. 1 is a block diagram showing the feedforward control system in the positioning apparatus 50, and FIG. 2 is a block diagram showing the feedback control system in the positioning apparatus 50. The positioning apparatus 50 is applicable to, for example, at least one of an original stage mechanism which positions an original and a substrate positioning mechanism which positions a substrate in an exposure apparatus which transfers the pattern of the original onto the substrate.

The positioning apparatus 50 can include a coarse moving stage (first member) 2 and the fine moving stage (second member) 1. The fine moving stage 1 can be supported on the coarse moving stage 2 by a support mechanism (not shown) which uses, for example, an air spring or a permanent magnet. The feedback control system in the positioning apparatus 50 will be described first with reference to FIG. 2. Laser light 33 from a laser interferometer (position measuring device) 32 is reflected by a reflecting mirror 31 placed on the fine moving stage 1, so the position of the fine moving stage 1 is measured by the laser interferometer 32. A subtracter 36 subtracts, from a position command value 35 for the fine moving stage 1 issued from a main controller MC, a position measurement value 34 of the fine moving stage 1 (the measurement result of the position of the fine moving stage 1) output from the laser interferometer 32, thereby generating a position error 37 of the fine moving stage 1.

A feedback controller 38 calculates a feedback control command value (to be abbreviated as an FB control command value hereinafter) 39, according to which the position error 37 is reduced, by, for example, PID calculation based on the position error 37. Note that the main controller MC, subtracter 36, and feedback controller 38 are formed by a digital processing circuit, and the FB control command value 39 can be converted into an analog signal by a D/A converter (not shown) and sent to a current driver 40. The current driver 40 supplies a current 41 corresponding to the FB control command value 39 to a fine moving linear motor 42. In accordance with the current 41, the fine moving linear motor 42 generates a thrust between the coarse moving stage (first member) 2 and the fine moving stage (second member) 1 to perform positioning control of the fine moving stage 1 using the thrust.

The coarse moving stage 2 is placed on a stage base 3 to be movable together with the fine moving stage 1 using a coarse guide 4 formed by, for example, a hydrostatic guide. Note that the movement of the coarse moving stage 2 can have at least one degree of freedom. The movement of the fine moving stage 1 can have at least one degree of freedom as well. The coarse moving stage 2 can have its position measured by a position measuring device such as a laser interferometer (not shown), and be driven by a coarse moving actuator (not shown), like the fine moving stage 1.

The feedforward control system in the positioning apparatus 50 will be described next with reference to FIG. 1. Electromagnets 5a and 5b are fixed to the coarse moving stage 2 so as to sandwich the fine moving stage 1 between them in the driving direction. In an example shown in FIG. 1, the electromagnets 5a and 5b are fixed to the coarse moving stage 2. Attraction targets 6a and 6b are fixed to the fine moving stage 1 so as to be attracted by the electromagnets 5a and 5b, respectively. Note that it is also possible to fix the electromagnets 5a and 5b to the fine moving stage 1, and fix the attraction targets 6a and 6b to the coarse moving stage 2.

Gaps are formed between the electromagnets 5a and 5b and the attraction targets 6a and 6b, respectively. The electromagnets 5a and 5b can be controlled so that the size of the gap between the electromagnet 5a and the attraction target 6a opposed to it has the same value as that of the gap between the electromagnet 5b and the attraction target 6b opposed to it.

The feedforward control system is individually provided to each of the electromagnets 5a and 5b. However, FIG. 1 shows only the feedback control system for the electromagnet 5a, for the sake of simplicity. Although the feedback control system for the electromagnet 5a will be described below as a representative, the feedback control system for the electromagnet 5b has the same configuration. The positioning apparatus 50 can include a magnetic flux sensor MFS which detects a magnetic flux value generated by the electromagnet 5a. The magnetic flux sensor MFS can include, for example, a search coil 7a and integrator 8. The search coil 7a is built into the electromagnet 5a including a driving coil 12a. The search coil 7a detects a temporal change in magnetic flux value generated by the electromagnet 5a, and outputs a magnetic flux change signal 21 indicating this change. The integrator 8 performs time integration of the magnetic flux change signal 21 detected by the search coil 7a, and outputs a magnetic flux detection value (a signal indicating the detection result of the magnetic flux generated by the electromagnet 5a) 22.

The positioning apparatus 50 also includes a gap sensor 14 and driving unit DU. The gap sensor 14 detects the size of the gap between the electromagnet 5a and the attraction target 6a, and outputs the detection result as a gap signal 28. In this embodiment, the gap sensor 14 outputs, as the gap signal 28, a digital signal indicating the size of the gap between the electromagnet 5a and the attraction target 6a. The driving unit DU corrects a basic magnetic flux command value 24 in accordance with the size of the gap detected by the gap sensor 14, thereby obtaining a corrected magnetic flux command value 25. Also, the driving unit DU drives the electromagnet 5a in accordance with an error between the corrected magnetic flux command value 25 and the magnetic flux detection value (magnetic flux value) 22 detected by the magnetic flux sensor MFS.

In this embodiment, the driving unit DU includes a correction value calculator 15, multiplier (corrector) 16, D/A converter 17, subtracter 9, amplifier (compensator) 10, and current driver 11. A force command value 23 issued by the main controller MC is converted into a basic magnetic flux command value 24 by a magnetic flux command calculator 13. In this embodiment, the basic magnetic flux command value 24 is a digital signal. The multiplier 16 multiplies the basic magnetic flux command value 24 by a correction value 29 from the correction value calculator 15 to generate a corrected magnetic flux command value 25. The “basic magnetic flux command value” and “corrected magnetic flux command value” are terms used to distinguish them from each other and are both magnetic command values. The D/A converter 17 converts the corrected magnetic flux command value 25 into an analog signal to generate an analog corrected magnetic flux command value 26. The subtracter 9 subtracts an analog magnetic flux detection value 22 from the analog corrected magnetic flux command value 26 to generate a magnetic flux error 27. The amplifier 10 multiplies the magnetic flux error 27 by a gain to generate an amplified magnetic flux error 30, and sends it to the current driver 11. The current driver 11 drives the driving coil 12a of the electromagnet 5a in accordance with the amplified magnetic flux error 30. This generates an attractive force between the electromagnet 5a and the attraction target 6a.

Note that a feedback loop which controls a magnetic flux (to be simply referred to as a magnetic flux feedback loop hereinafter) is formed by the magnetic flux sensor MFS, subtracter 9, amplifier (compensator) 10, current driver 11, and electromagnet 5a (driving coil 12a). The magnetic flux feedback loop causes a magnetic flux generated by the driving coil 12a to follow the corrected magnetic flux command value 26 serving as a command value for the magnetic feedback loop. An attractive force generated between the electromagnet 5a and the attraction target 6a is determined based on the value of a magnetic flux generated by the driving coil 12a, and the size of the gap between the electromagnet 5a and the attraction target 6a.

A reference value for the size of the gap between the electromagnet 5a and the attraction target 6a will be referred to as a standard gap hereinafter. The multiplier 16 corrects the basic magnetic flux command value 24 in accordance with the correction value 29 generated in accordance with the gap signal 28 by the correction value calculator 15, thereby reducing a fluctuation in attractive force due to the amount (to be simply referred to as the amount of gap fluctuation hereinafter) of fluctuation in size of the gap between the electromagnet 5a and the attraction target 6a from the standard gap. Also, the value of a magnetic flux generated by the driving coil 12a follows the corrected magnetic flux command value 26, as described earlier. Upon this operation, an attractive force generated between the electromagnet 5a and the attraction target 6a follows the force command value 23 serving as a command value for the feedforward control system shown in FIG. 1.

To improve the control accuracy of an attractive force generated between the electromagnet 5a and the attraction target 6a, the magnetic feedback loop preferably operates at high frequencies on the order of kilohertz or more. A digital control system poses a problem resulting from a time delay associated with the sampling time, so it is difficult for this system to increase the gain of the amplifier (compensator) 10 and, in turn, to attain a high frequency band. Hence, the subtracter 9 and amplifier 10 are preferably formed using an analog operational amplifier (OP amplifier). Similarly, the integrator 8 is preferably formed using an analog operational amplifier (OP amplifier). Since the magnetic flux command calculator 13 generally performs nonlinear computation, it is difficult to form the magnetic flux command calculator 13 using an analog circuit. Therefore, the magnetic flux command calculator 13 can be typically formed using a digital processing circuit.

The change in size of the gap between the electromagnet 5a and the attraction target 6a opposed to it results from a response by the coarse moving stage 2 and is about 1 kHz at best, as will be described later, so the correction value calculator 15 need not be formed using an analog circuit. Also, the multiplier 16 multiplies the value output from the magnetic flux command calculator 13 and that output from the correction value calculator 15. For this reason, when the magnetic flux command calculator 13 is formed using a digital processing circuit, the correction value calculator 15 is desirably formed using a digital processing circuit as well.

An operation of accelerating, to the right in FIG. 1, the coarse moving stage 2 and the fine moving stage 1 supported by it will be described herein. A coarse moving actuator (not shown) which drives the coarse moving stage 2 generates a driving force for driving both the coarse moving stage 2 and the fine moving stage 1 supported by it to drive the coarse moving stage 2. The driving force generated by the coarse moving actuator is transmitted to the fine moving stage 1 via the electromagnet 5a and fine moving linear motor 42. Hence, in driving the coarse moving stage 2 by the coarse moving actuator, at least one of the fine moving linear motor 42 and an electromagnetic actuator formed by the electromagnet 5a and attraction target 6a must generate a force. However, the fine moving linear motor 42 generates a large amount of heat. Therefore, the feedforward control system shown in FIG. 1 preferably causes the electromagnet 5a which achieves a high thrust and low heat generation to generate a driving force for acceleration, and the feedback control system shown in FIG. 2 preferably causes the fine moving linear motor 42 to generate only a driving force for position control of the fine moving stage 1.

When the relative position between the coarse moving stage 2 and the fine moving stage 1 fluctuates upon acceleration of the coarse moving stage 2 and fine moving stage 1, the positioning accuracy of the fine moving stage 1 degrades. Hence, to improve the positioning accuracy of the fine moving stage 1, the control accuracy of the feedforward control system shown in FIG. 1 must be improved. A force generated by the electromagnet 5a is controlled using the driving unit DU to control the value of a magnetic flux generated by the electromagnet 5a, so the relationship between a magnetic flux command value and a force generated in accordance with the magnetic flux command value must be obtained in advance.

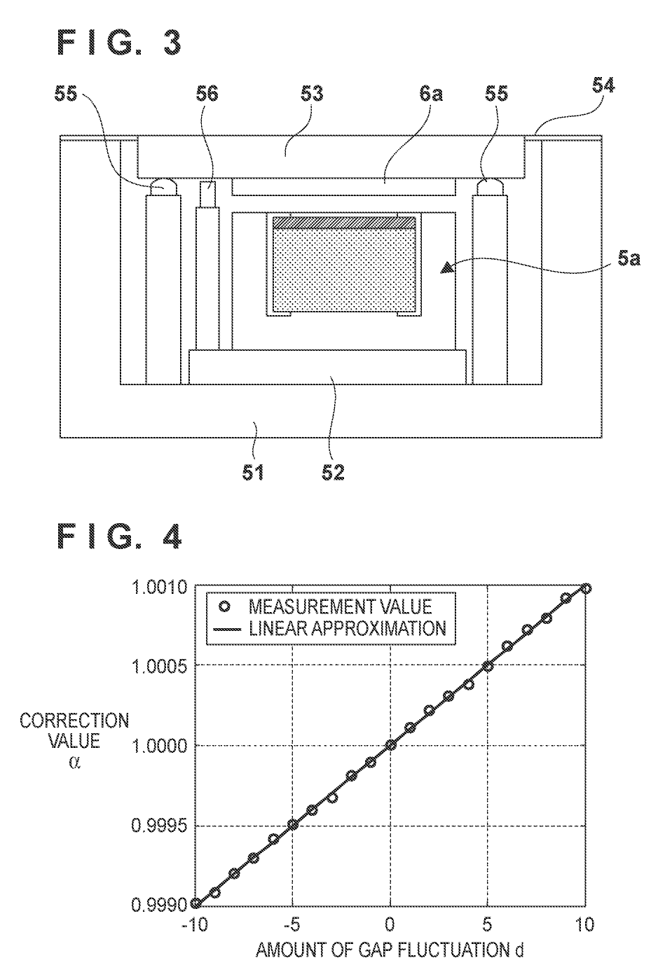

FIG. 3 illustrates the configuration of a measuring device which measures the characteristics of an electromagnetic actuator formed by an electromagnet and an attraction target. To measure the characteristics of the electromagnetic actuator formed by the electromagnet 5a and attraction target 6a, this electromagnetic actuator can be built into the measuring device illustrated in FIG. 3. This measuring device can be used to measure the relationship between a magnetic flux command value (for example, the basic magnetic flux command value 24) and a force generated in accordance with the magnetic flux command value, when the gap has the size of the standard gap. The same applies to an electromagnetic actuator formed by the electromagnet 5b and attraction target 6b.

The electromagnet 5a can be fixed to an electromagnet mounting plate 52 supported by a base 51. The attraction target 6a can be fixed to a target mounting plate 53 supported by the base 51 via a leaf spring 54. By the action of the leaf spring 54, the attraction target 6a can move in the direction in which it is attracted to the electromagnet 5a. An attractive force acting between the electromagnet 5a and the attraction target 6a can be measured by load cells 55 disposed between the base 51 and the target mounting plate 53. A gap sensor 56 is placed on the electromagnet mounting plate 52 so that the size of the gap between the electromagnet 5a and the attraction target 6a can be measured. The electromagnet mounting plate 52 can include a mechanism capable of adjusting this gap.

The electromagnet 5a is connected to the feedforward control system shown in FIG. 1. By adjusting the electromagnet mounting plate 52, the size of the gap between the electromagnet 5a and the attraction target 6a can be set to that of the standard gap. In this state, the attractive force is measured by the load cells 55 while changing the magnetic flux command value (for example, the basic magnetic flux command value 24), thereby obtaining the relationship between a magnetic flux (magnetic flux command value) and a force generated in accordance with the magnetic flux. The relationship between the magnetic flux and the force can be approximated by a quadratic function having the magnetic flux as an argument. The inverse function of this quadratic function is set in the magnetic flux command calculator 13 to determine the basic magnetic flux command value 24 from the force command value 23 in accordance with this inverse function.

The size of the gap between the electromagnet 5a and the attraction target 6a desirably does not change from that of the standard gap, but may change upon driving of the coarse moving stage 2 and fine moving stage 1 in practice. This may occur due mainly to a position error of the coarse moving stage 2. The coarse moving stage 2 may have a position error larger than that of the fine moving stage 1 due to disturbances such as the resistance of the coarse guide 4 and that produced by the spring property as an electrical system and pipes of a supply/exhaust system are connected to external devices. The size of the gap may also deviate from that of the standard gap upon initialization of the coarse moving stage 2 and fine moving stage 1.

Even if the size of the gap between the electromagnet 5a and the attraction target 6a fluctuates, a change in value of the magnetic flux due to this fluctuation is canceled by the magnetic flux feedback loop including the search coil 7a. However, a magnetic flux component which does not contribute to producing an attractive force between the electromagnet 5a and the attraction target 6a and flows only in the electromagnet 5a is present, and is also detected by the search coil 7a. This magnetic flux component depends on the size of the gap, so the attractive force may change upon a fluctuation in size of the gap even if the value of the magnetic flux is controlled to be constant.

Hence, as long as the relationship between an amount of fluctuation (to be simply referred to as the amount of gap fluctuation hereinafter) d of size in gap between the electromagnet 5a and the attraction target 6a, and a magnetic flux command value according to which a change in magnetic flux value due to the amount of gap fluctuation d is canceled is obtained, the basic magnetic flux command value 24 can be corrected based on this relationship. A calculation equation for calculating a correction value 29 by the correction value calculator 15 can be determined using the following method. First, a basic magnetic flux command value 24 for the standard gap is obtained in accordance with a given force command value 23 and defined as X. Then, the size of the gap is changed from that of the standard gap and the electromagnet 5a is driven to adjust the basic magnetic flux command value 24 so that the attractive force has the force command value 23. Letting Y be the adjusted, basic magnetic flux command value 24, a correction value a is given by α=Y/X. The relationship between the amount of gap fluctuation d and the correction value α can be determined by changing the amount of gap fluctuation d and measuring this relationship. FIG. 4 illustrates the relationship between the amount of gap fluctuation d and the correction value α. In an example shown in FIG. 4, the relationship between the amount of gap fluctuation d and the correction value α is described by a linear function. The correction value calculator 15 determines the correction value α using this linear function. When the correction value α depends on the generated force, the function for determining the correction value α may be changed in accordance with the force command value 23. As described above, an attractive force generated by the electromagnetic actuator formed by the electromagnet 5a and attraction target 6a can be controlled with high accuracy by correcting the magnetic flux command value in accordance with the size of the gap between the electromagnet 5a and the attraction target 6a. This makes it possible to position the fine moving stage 1 with high accuracy.

In decelerating the coarse moving stage 2 and fine moving stage 1 accelerating to the right in FIG. 1, the electromagnetic actuator formed by the electromagnet 5b and attraction target 6b is activated. On the other hand, in accelerating the coarse moving stage 2 and fine moving stage 1 to the left in FIG. 1, the electromagnetic actuator formed by the electromagnet 5b and attraction target 6b is activated. Also, in decelerating the coarse moving stage 2 and fine moving stage 1 accelerating to the left in FIG. 1, the electromagnetic actuator formed by the electromagnet 5a and attraction target 6a is activated.

The function for obtaining the basic magnetic flux command value 24 from the force command value 23, and that for obtaining the correction value 29 from the gap signal 28 may be replaced with conversion tables corresponding to them.

Although the magnetic feedback loop can be formed using an analog circuit in the above-mentioned example, it may be formed using a digital circuit. Although the gap signal 28 is obtained by the gap sensor 14 in the above-mentioned example, it may be calculated from the position measurement values of the fine moving stage 1 and coarse moving stage 2. Also, although FIGS. 1 and 2 illustrate only a driving mechanism about one axis for the sake of descriptive simplicity, a driving mechanism about two or more axes can be provided.

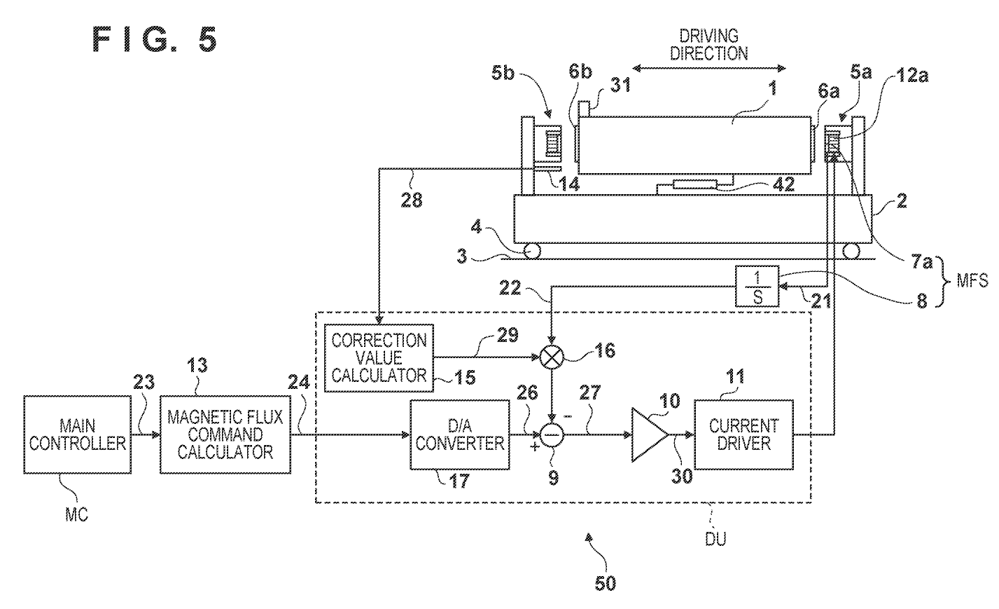

Although the basic magnetic flux command value 24 is corrected in accordance with the correction value 29 generated by the correction value calculator 15 to generate the corrected magnetic flux command value 25 in the configuration example shown in FIG. 1, the magnetic flux detection value 22 may be corrected in accordance with the correction value 29 instead, as illustrated in FIG. 5. The configuration examples shown in FIGS. 1 and 5 show equivalent configurations that generate equal magnetic flux errors 27.

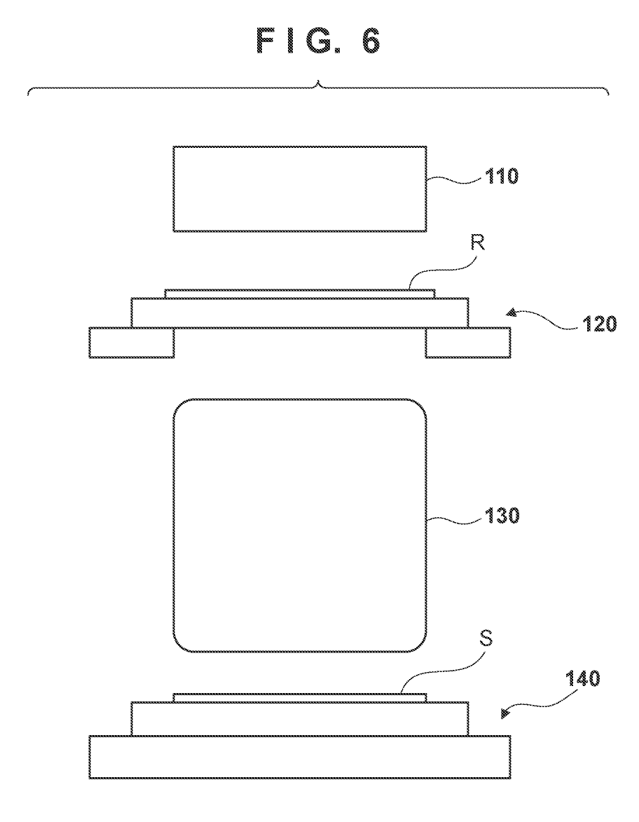

An exposure apparatus as an application example of the positioning apparatus according to the present invention will be described below with reference to FIG. 6. The exposure apparatus according to an embodiment of the present invention includes an original positioning mechanism 120 which positions an original R, a substrate positioning mechanism 140 which positions a substrate S, an illumination system 110 which illuminates the original R, and a projection system 130 which projects the pattern of the original R onto the substrate S. Note that the positioning apparatus 50 exemplified with reference to FIGS. 1 and 2 is applicable to at least one of the original positioning mechanism 120 and the substrate positioning mechanism 140.

An application example of the above-mentioned exposure apparatus will be described next. A method of manufacturing a device according to an embodiment of the present invention is suitable for manufacturing a device such as a semiconductor device or a liquid crystal device. This method can include a step of exposing a substrate coated with a photosensitive agent using the above-mentioned exposure apparatus, and a step of developing the exposed substrate. This method can also include subsequent known steps (for example, oxidation, film formation, vapor deposition, doping, planarization, etching, resist removal, dicing, bonding, and packaging).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-103787, filed May 6, 2011, which is hereby incorporated by reference herein in its entirety.

What is claimed is:

1. A positioning apparatus which controls a relative position between a first member and a second member, comprising:
an electromagnet fixed to the first member;
an attraction target fixed to the second member so as to be attracted by the electromagnet;
a magnetic flux sensor which detects a magnetic flux value generated by the electromagnet; and
a driving unit which drives the electromagnet in accordance with an error between the magnetic flux value detected by the magnetic flux sensor and a corrected magnetic flux command value obtained by correcting a magnetic flux command value in accordance with a size of a gap between the electromagnet and the attraction target.

2. The apparatus according to claim 1, further comprising:
a main controller which generates a force command value that is a command value for a force generated between the electromagnet and the attraction target; and
a magnetic flux command calculator which generates the magnetic flux command value based on the force command value.

3. The apparatus according to claim 1, wherein the first member includes a coarse moving stage, and the second member includes a fine moving stage supported by the coarse moving stage.

4. The apparatus according to claim 1, further comprising a gap sensor which detects the size of the gap between the electromagnet and the attraction target.

5. A positioning apparatus which controls a relative position between a first member and a second member, comprising:
an electromagnet fixed to the first member;
an attraction target fixed to the second member so as to be attracted by the electromagnet;
a magnetic flux sensor which detects a magnetic flux value generated by the electromagnet; and
a driving unit which drives the electromagnet in accordance with an error between a magnetic flux command value and a magnetic flux value obtained by correcting the magnetic flux value, detected by the magnetic flux sensor, in accordance with a size of a gap between the electromagnet and the attraction target.

6. The apparatus according to claim 5, further comprising:
a main controller which generates a force command value that is a command value for a force generated between the electromagnet and the attraction target; and
a magnetic flux command calculator which generates the magnetic flux command value based on the force command value.

7. The apparatus according to claim 5, wherein the first member includes a coarse moving stage, and the second member includes a fine moving stage supported by the coarse moving stage.

8. The apparatus according to claim 5, further comprising a gap sensor which detects the size of the gap between the electromagnet and the attraction target.

9. An exposure apparatus which transfers a pattern of an original onto a substrate, comprising:
an original positioning mechanism which positions the original;
a substrate positioning mechanism which positions the substrate;
an illumination system which illuminates the original; and
a projection system which projects the pattern of the original onto the substrate,
wherein at least one of the original positioning mechanism and the substrate positioning mechanism includes a positioning apparatus which controls a relative position between a first member and a second member,
the positioning apparatus comprising:
an electromagnet fixed to the first member;
an attraction target fixed to the second member so as to be attracted by the electromagnet;
a magnetic flux sensor which detects a magnetic flux value generated by the electromagnet; and
a driving unit which drives the electromagnet in accordance with an error between the magnetic flux value detected by the magnetic flux sensor and a corrected magnetic flux command value obtained by correcting a magnetic flux command value in accordance with a size of a gap between the electromagnet and the attraction target.

10. An exposure apparatus which transfers a pattern of an original onto a substrate, comprising:
an original positioning mechanism which positions the original;
a substrate positioning mechanism which positions the substrate;
an illumination system which illuminates the original; and
a projection system which projects the pattern of the original onto the substrate,
wherein at least one of the original positioning mechanism and the substrate positioning mechanism includes a positioning apparatus which controls a relative position between a first member and a second member,
the positioning apparatus comprising:
an electromagnet fixed to the first member;
an attraction target fixed to the second member so as to be attracted by the electromagnet;
a magnetic flux sensor which detects a magnetic flux value generated by the electromagnet; and
a driving unit which drives the electromagnet in accordance with an error between a magnetic flux command value and a magnetic flux value obtained by correcting the magnetic flux value, detected by the magnetic flux sensor, in accordance with a size of a gap between the electromagnet and the attraction target.

11. A method of manufacturing a device, comprising the steps of:
exposing a substrate by an exposure apparatus which transfers a pattern of an original onto the substrate; and
developing the substrate,
wherein the exposure apparatus, comprises:
an original positioning mechanism which positions the original;
a substrate positioning mechanism which positions the substrate;
an illumination system which illuminates the original; and
a projection system which projects the pattern of the original onto the substrate,
wherein at least one of the original positioning mechanism and the substrate positioning mechanism includes a positioning apparatus which controls a relative position between a first member and a second member,
the positioning apparatus comprising:
an electromagnet fixed to the first member;
an attraction target fixed to the second member so as to be attracted by the electromagnet;
a magnetic flux sensor which detects a magnetic flux value generated by the electromagnet; and
a driving unit which drives the electromagnet in accordance with an error between the magnetic flux value detected by the magnetic flux sensor and a corrected magnetic flux command value obtained by correcting a magnetic flux command value in accordance with a size of a gap between the electromagnet and the attraction target.

12. A method of manufacturing a device, comprising the steps of:
exposing a substrate by an exposure apparatus which transfers a pattern of an original onto the substrate; and
developing the substrate,
wherein the exposure apparatus, comprising:
an original positioning mechanism which positions the original;
a substrate positioning mechanism which positions the substrate;
an illumination system which illuminates the original; and
a projection system which projects the pattern of the original onto the substrate,
wherein at least one of the original positioning mechanism and the substrate positioning mechanism includes a positioning apparatus which controls a relative position between a first member and a second member,
the positioning apparatus comprising:
an electromagnet fixed to the first member;
an attraction target fixed to the second member so as to be attracted by the electromagnet;
a magnetic flux sensor which detects a magnetic flux value generated by the electromagnet; and
a driving unit which drives the electromagnet in accordance with an error between a magnetic flux command value and a magnetic flux value obtained by correcting the magnetic flux value, detected by the magnetic flux sensor, in accordance with a size of a gap between the electromagnet and the attraction target.
